(19) United States
(12) Patent Application Publication
(10) Pub. No.: US 2026/0324592 A1
(43) Pub. Date: Oct. 22, 2026

(54) CORRECTIVE ANIMAL COLLAR WITH AUTONOMOUS HEIGHT DETECTOR AND METHOD OF USING THE SAME

(71) Applicant: Greenvestments, LLC, Wilmette, IL (US)

(72) Inventor: Adam Greenberg, Wilmette, IL (US)

(21) Appl. No.: 19/184,255

(22) Filed: Apr. 21, 2025

(51) Int. Cl. A01K 15/02; A01K 27/00

(52) U.S. Cl. CPC A01K 15/021; A01K 27/001

(57) ABSTRACT

A collar is provided. The collar includes a strap configured to by an animal, and a sensor at the strap. The sensor is configured to measure a height of the sensor in relation to a ground level. The collar further includes a processor configured to receive the height measurement from the sensor, to compare the height measurement to a predetermined threshold height, and to provide feedback to the animal when the height measurement from the sensor is greater than the predetermined threshold height. The feedback is intended to address animal behavior.

### BACKGROUND

Animal jumping or an animal standing on its hind legs may be considered undesirable behavior. For example, animals, such as dogs, jumping on houseguests is a common issue that may range from annoying to dangerous, especially if the animal is large or excitable. While the animal might be excited or trying to greet people, this behavior may intimidate or even knock someone over. If the jumping is not corrected, the animal may learn that jumping is an acceptable way to get attention, reinforcing the behavior.

In addition to greeting houseguests, animals may also jump to access food on tables or kitchen counters, which may be frustrating and potentially harmful if the animal ingests something like chocolate, onions, or bones. Moreover, animals may jump onto furniture, stand on their hind legs at windows or doors to bark at passersby, jump and interfere with tabletop games, and/or jump over fences or gates that are placed inside or outside. Any of these jumping activities may be dangerous for the animal and frustrating for the owner.

Over time, if an animal's jumping behavior is rewarded with attention, positive or negative or the behavior is not imminently addressed, the behavior becomes harder to break. Some conventional correction collars for addressing an animal's jumping behavior rely on communication between an animal owner and the correction collar when the behavior occurs. For example, when an animal owner sees his/her animal jump on the counter, the owner may issue a correction via a remote control to the correction collar. This may be useful when the owner sees the bad behavior occur; however, when the owner is turned around or in another room or cannot find the remote, the owner may fail to issue a prompt correction via the remote control. Thus, the animal may receive inconsistent training or feedback, which may prolong the time necessary to properly train the animal and/or prevent jumping. It would be useful to have an improved corrective collar to address jumping that does not involve manual intervention by the animal owner through a remote control each time the animal jumps.

Moreover, other conventional correction collars may administer a shock to an animal wearing the correction collar. These collars may rely on intervention and communication between the correction collar and additional external components, such as components that are buried underground in an owner's yard or components mounted on walls in a room. The additional components tend to be more expensive and must be positioned properly to communicate with the correction collar. Moreover, due to the fixed nature of the additional external components, the collar is limited to applying corrections in the space containing the external components. It would be useful to have an improved corrective collar to address jumping that does not require components in addition to the collar for proper operation.

### SUMMARY

In one implementation, a collar is provided. The collar includes a strap configured to be worn by an animal, and a sensor provided at the strap. The sensor is configured to measure a height of the sensor in relation to a ground level. The collar also includes a processor configured to receive the height measurement from the sensor, to compare the height measurement to a predetermined threshold height, and to provide feedback to the animal when the height measurement from the sensor is greater than the predetermined threshold height.

In another implementation, a collar including a housing is provided. The collar includes a strap configured to be worn by an animal, a housing coupled to the strap, and a sensor coupled to the housing. The sensor is configured to measure a height of the sensor in relation to a ground level. The collar further may include a processor configured to receive the height measurement from the sensor, to compare the height measurement to a predetermined threshold height, and to provide feedback to the animal when the height measurement from the sensor is greater than the predetermined threshold height.

In a further implementation, a method of controlling animal behavior via an animal collar is provided. The animal collar includes a strap. The method includes providing the collar including a strap, and measuring, via a sensor at the strap, a height of the sensor in relation to a surface. The method also includes comparing, via a processor, the measured height of the sensor to a threshold height, and outputting corrective feedback via the collar to control behavior of the animal when the measured height is greater than the threshold height configured to modify behavior of the animal.

### BRIEF DESCRIPTION OF THE FIGURES

FIG. 1 is an isometric view of an animal wearing an example corrective collar.

FIG. 2 is an isometric view of the corrective collar of FIG. 1.

FIG. 3 is another isometric view of the corrective collar of FIGS. 1 and 2.

FIG. 4 is a flow chart illustrating an example method of operation of the corrective collar of FIGS. 1-3.

### DETAILED DESCRIPTION

Example embodiments will now be described more fully hereinafter with reference to the accompanying drawings.

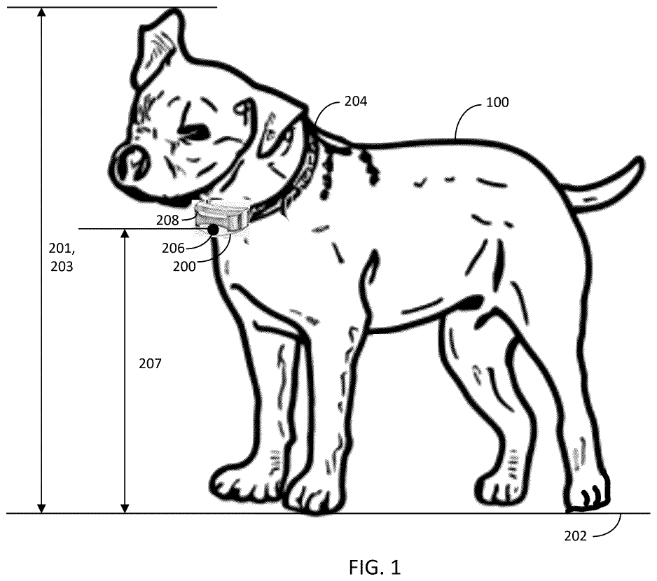

FIG. 1 is an animal 100 wearing a corrective collar 200 to minimize undesired behavior. When an animal jumps or stands on its hind legs, it may be considered undesired behavior. The animal, such as a dog, may wear the collar 200 around its neck. The animal may have a height 203 measured from (e.g., a top of) the head of the animal to the ground 202, such as the floor. The corrective collar 200 includes a strap 204 with at least one sensor 206 to measure a height 207 between the sensor 206 and a surface, such as the ground 202, and a processor 208 configured to be in communication with the sensor 206 and to provide feedback to the animal 100 to address the undesired behavior.

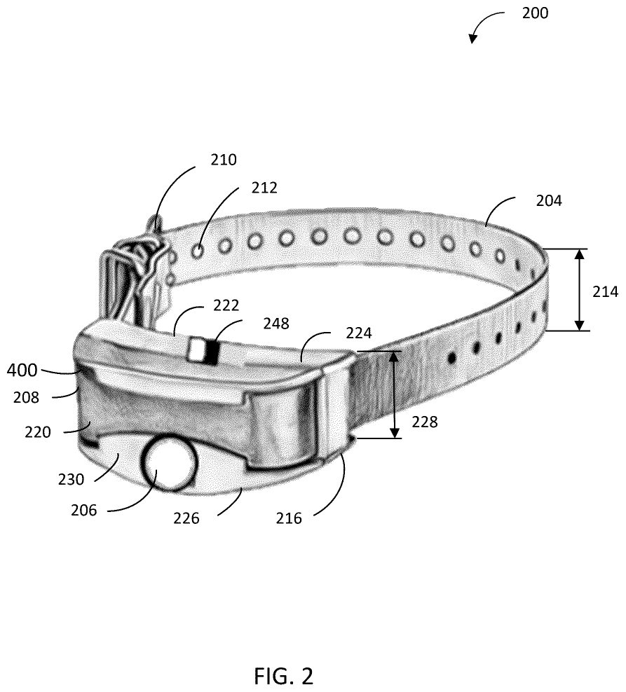

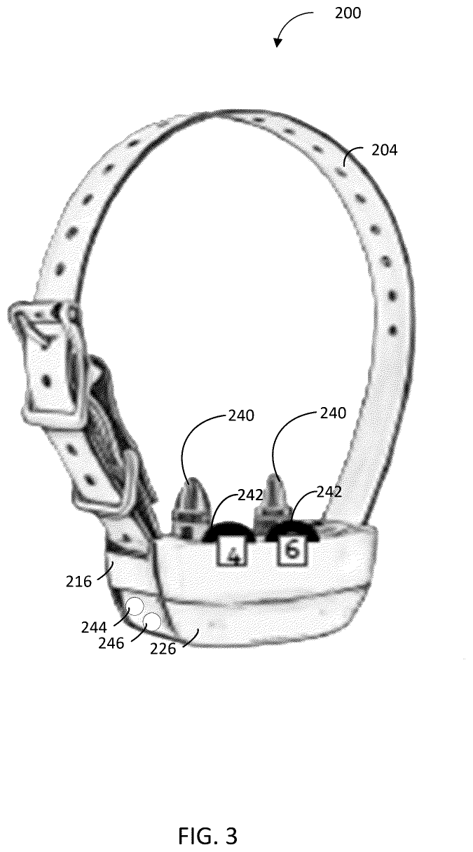

Turning to FIGS. 2 and 3, in an example embodiment, the strap 204, when worn by the animal 100, may be contoured to securely fit around the animal's neck and may facilitate positioning the sensor 206 on the underside of the animal's neck (e.g., underneath and/or behind the animal's jaw). The strap 204 may be provided as a flexible, lightweight material to be comfortable when worn, to be easily cleaned, and to be waterproof. Example lightweight materials may include rubber, nylon, leather, vinyl, plastic, a combination thereof, and/or other suitable materials. In another example embodiment, the strap 204 may be shaped and sized differently.

The strap 204 may further include a securing mechanism 210, such as a buckle, clip, ring, and/or the like, configured to secure the strap 204 to the neck of the animal 100. The securing mechanism 210 allows the strap 204 to be adjusted to fit different neck sizes. For example, when the securing mechanism 210 is a buckle, the strap 204 may include a plurality of openings 212 to receive at least a portion of the buckle therein. Additionally, the strap 204 may have a width 214, which may be dependent on the size of the animal 100. The width 214 of the strap 204 may be between about 0.5 inches (1.27 centimeters) to about 3 inches (7.62 centimeters), or about 1 inch (2.54 centimeters). The width 214 of the strap 204 may fit securely around the neck of the animal 100 without restricting the movement of the animal and without causing discomfort to the animal.

In an example embodiment, the strap 204 may include an optional housing 216. When the collar 200 includes the housing 216, the sensor 206 and/or the processor 208 may be positioned within at least a portion of the housing 216. The housing 216 may include at least one slot to accommodate the strap 204 therein. As shown in at least FIGS. 2 and 3, in an example embodiment, the housing 216 may have a substantially rectangular shape including at least a first (e.g., front) surface 220 and an opposing second (e.g., rear) surface 222, and a third (e.g., top) surface 224 and an opposing fourth (e.g., bottom) surface 226 extending between the first surface 220 and the second surface 222. Although shown as a rectangular shape, other shapes are possible, such as a round shape. Moreover, the housing 216 may have a width 228 that is substantially equal to or slightly greater than the width 214 of the strap 204.

The strap 204 of the collar 200 may include an optional transparent portion 230 such that the sensor 206 may sense through the transparent portion 230. The transparent portion 230 may be fully transparent or semi-transparent and may prevent the sensor 206 from being covered in dust or debris. The transparent portion 230 may be provided in the form of a plastic to be durable, scratch-resistant, shatterproof, waterproof, and resistant to wear and tear. Other materials for the transparent portion 230 are possible.

Additionally, the strap 204 may include at least one prong or a pair of prongs 240 (as best shown in FIG. 3) extending outward from the strap 204. The prongs 240 may be metal and each prong 240 may have a cone shape to transmit corrective feedback to the neck of the animal 100. Each prong 240 may vibrate or release an electric shock. When the pair of prongs 240 is provided, each prong 240 may operate independent of the other prong. Other shapes, materials, numbers of prongs, and/or feedback are possible.

The collar 200 further may include an input mechanism 242. The input mechanism 242 is configured to receive an input, such as a predetermined threshold height 201. In an example embodiment, the predetermined threshold height 201 is the height 203 of the animal 100. In other example embodiments, the predetermined threshold height 201 may be greater than the height 203 of the animal 100.

In an example embodiment, the input mechanism 242 is a pair of dials (as best shown in FIG. 3). When the collar 200 includes the optional housing 216, the input mechanism 242, such as each dial of the pair of dials, may be positioned within at least one of the second surface 222 or the fourth surface 226 of the housing 216 and may be aligned with the pair of prongs 240. In another embodiment when the housing 216 is not provided, the input mechanism 242, such as the pair of dials, may be part of the strap 204.

Each dial may have a label with a plurality of numbers, such as numbers 0 to 10. In an example embodiment, one dial of the pair of dials may represent the predetermined threshold height 201 in feet, and the other dial in the pair of dials may represent the predetermined threshold height in inches. For example, as shown in FIG. 3, one dial is shown with a label of “4” and the other dial is shown with a label of “6,” such that the “4” represents 4 feet and the “6” represents 6 inches. In this example, the predetermined height threshold 201 is 4 feet 6 inches. At least one dial is connected to an electronic component, such as a rotary switch, potentiometer, and/or a rotary encoder. The numbers on the at least one dial may be a visual cue, and the processor 208 may determine the predetermined threshold height 201 based on the electronic position of the at least one dial. Thus, the at least one dial is in communication with the processor 208. Moreover, when the input mechanism 242 is the at least one dial, the predetermined threshold height 201 may be adjusted by rotating the dial. In an example embodiment, when the pair of dials includes a “0” as a label, selecting the “0” for both the (e.g., feet and inches) dials may indicate that no threshold height is selected and/or may indicate the collar 200 is off and not operating.

In a further example embodiment, the input mechanism 242 may be a display (e.g., in addition to or in alternative to the pair of dials), with or without a button, and the predetermined threshold height 201 may be input using the display and/or the button. When a display is provided, the display may include a graphical user interface for an owner or user to digitally input the predetermined threshold height 201. For example, the graphical user interface may be a digital number pad for inputting the predetermined threshold height in feet and inches. The graphical user interface may be in communication with the processor 208, such that the processor 208 may receive the predetermined threshold height 201 from the graphical user interface and may store the predetermined threshold height 201. When the feet and inches on the display are both selected as “0”, this may indicate that no threshold height is selected or may indicate the collar 200 is off and not operating. Moreover, in an example embodiment, when the input mechanism 242 has a display, the display may electrically communicate with an external device, such as a smartphone or the like. In such an example embodiment, the predetermined threshold height 201 is entered into the display and/or entered into the external device.

The collar 200 may provide corrective feedback to the animal. The feedback may include a vibration, a shock (e.g., static correction), an audible noise, a visual alert, a combination thereof, or other suitable feedback. The feedback, such as the vibration or the shock, is configured to provide mild and temporary physical discomfort to the animal wearing the collar. The discomfort is configured to be temporary and to get the attention of the animal. As the collar 200 continues to provide feedback consistently to the animal, the animal may learn to modify its behavior through association. For example, the animal may learn that certain undesirable behavior may lead to the unpleasant sensation from the vibration or shock, and, thus, the animal may adjust its behavior to avoid the vibration or feedback.

The collar 200 also may include at least one switch 248 to select the feedback to be delivered by the collar 200 to the animal. The switch 248 may provide one or more feedback options, such that the switch 248 may be configured to toggle between a first feedback option and a second feedback option. By toggling the switch 248 between the first feedback option and the second feedback option, an electrical connection inside the switch 248 is changed, which allows the processor 208 to detect the position of the switch 248 and thus implement the selected feedback option. In an example embodiment, the first feedback option may be a vibration setting configured to deliver a vibration through at least one prong 240 to the neck of the animal and/or the second feedback option may be a shock setting configured to deliver a shock through at least one prong 240 to the neck of the animal. In another example embodiment, the switch 248 may be configured to change the intensity of the feedback. In a further example embodiment, the switch 248 may have any number of feedback options.

Continuing with FIGS. 2 and 3, the collar 200 further may include a battery 244 configured to provide power to the collar 200 including powering the at least the sensor 206 and/or the processor 208. The battery 244 may be a rechargeable (e.g., lithium-ion) battery. Moreover, in this example embodiment, the collar 200 may include a port to receive a battery charger therein to facilitate charging the rechargeable battery. In the example embodiment including the rechargeable battery, the collar 200 may further include a light emitting diode (LED) light 246 to indicate whether the battery is charging. For example, the LED light 246 may be red when the battery 244 is not charging and may be green when the battery is charging. Moreover, the LED light 246 may show whether the collar 200 and/or the battery 244 is active (e.g., on), inactive (e.g., off), and/or whether the battery 244 is low and could use to be charged. Alternatively or additionally, the collar 200 may include a replaceable battery, such as a button cell battery. Other battery options are possible.

The sensor 206, as shown in FIG. 3, may be positioned on or within the strap 204 of the collar 200. In an example embodiment, the sensor 206 has lidar to measure at least one distance or height using laser light, such as the height measurement 207. The height measurement 207 may be communicated to the at least one of the processor 208 and the height measurement 207 may be stored in the memory. The sensor 206 may continuously scan and update the height measurement 207 multiple times per second. Further, the sensor 206 may sense the height measurement 207 at predetermined time intervals, such as three times per second or 10 times per second. Moreover, the sensor 206 may be configured to scan the ground 202 at one or more rates, such as at 10 hertz (Hz), 20 Hz, or 30 Hz.

Additionally, the sensor 206 of the collar 200 may have an altimeter. The altimeter is configured to (e.g., continuously) sense the height measurement 207 of the sensor 206 with respect to the ground 202. The altimeter measures the altitude with respect to the ground to determine the height measurement 207 of the collar 200. The altimeter provides a supplemental height measurement 207 performed after the sensor 206 has determined an initial height measurement 207 with lidar. The supplemental measurement may be compared to the initial height measurement 207 to verify that both the initial and supplemental height measurements are within a predetermined discrepancy amount, such as within 1 inch. If a difference between the secondary height measurement and the initial height measurement is greater than the predetermined discrepancy amount, the processor 208 may cease not administer feedback through the collar 200.

Moreover, the collar 200 may include an accelerometer to determine the orientation of the collar 200. For example, the accelerometer may measure acceleration forces, including the constant force of gravity. When the collar 200 is at rest, gravity pulls the collar 200 in a specific direction, and the accelerometer may sense this pull across three axes, such as an X-axis, a Y-axis, and a Z-axis. By analyzing how gravity is distributed among the three axes, the accelerometer may determine the orientation of the collar 200. For example, the accelerometer may determine whether the collar 200 is upright, tilted, lying flat, or upside down, and may detect changes in the body position or activity of the animal. The accelerometer may be in communication with the processor 208. The accelerometer may provide the collar 200 with an output of the orientation (e.g., position), even when the accelerometer or collar 200 is not moving. Moreover, when the processor 208 receives an output from the accelerometer that the collar 200 is not moving, such as the animal is lying down, or receives an output that the collar 200 is improperly positioned on the animal's neck (e.g., the collar 200 is riding up on the neck of the animal), the processor 208 may deactivate or turn off the collar 200 to prevent the animal from receiving unnecessary feedback. In an example embodiment, if the processor 208 deactivates the collar 200, the processor 208 may alert with an audible sound to notify the owner that the collar 200 has been deactivated.

The processor 208 may be any suitable processor, such as a general-purpose processor (e.g., microprocessor) or a special-purpose processor (e.g., a digital signal processor DSP). For example, the processor 208 has a 32-bit core architecture with clock speeds between about 64 megahertz (MHz) and about 100 MHz, and may operate at a voltage of about 1.7 volts (V) to about 3.6 Volts. Moreover, the processor 208 may have an onboard flash memory, such as a memory of about 1 megabyte (MB) and random access memory (RAM) of about 256 kilobytes (KB). Further, the processor 208 may have integrated wireless capabilities, such as Bluetooth Low Energy (BLE). Moreover, the processor 208 may support a plurality of interfaces for electronically communicating with the sensor 206 (e.g., lidar, altimeter, and accelerometer). Moreover, the processor 208 may be compact. Other suitable processors with other clock speeds, voltages, memory, and/or capabilities are possible.

The collar 200 may further include a computing device 400, as shown in FIG. 2, configured to perform and/or can perform one or more acts and/or functions, such as those described in this disclosure. The computing device 400 can include various components, such as at least one sensor (e.g., the sensor 206), a processor (e.g., the processor 208), a data storage unit, an optional communication interface, a user interface (e.g., the input mechanism 242), and/or a memory. Each of these components can be connected to each other via a connection mechanism.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The sensor of the computing device 400 may be the sensor 206 of the collar 200 or may be another sensor. The sensor of the computing device 400 and/or the sensor 206 of the collar 200 can include sensors now known or later developed, including but not limited to a lidar sensor, an altimeter sensor, an accelerometer sensor, a sound detection sensor, a motion sensor, a proximity sensor, a location sensor (e.g., a GPS sensor), a time sensor (e.g., a digital clock), a camera sensor, a device interaction sensor, and/or a combination of these sensors, among other possibilities.

The processor of the computing device 400 may be the processor 208 of the collar 200 or may be another processor. The processor 208 of the collar 200 and/or the processor of the computing device 400 can include a general-purpose processor (e.g., a microprocessor) and/or a special-purpose processor (e.g., a digital signal processor (DSP)), among other possibilities. The processor can execute program instructions included in the data storage unit.

The data storage unit of the computing device 400 can include one or more volatile, non-volatile, removable, and/or non-removable storage components, such as magnetic, optical, and/or flash storage, and/or can be integrated in whole or in part with the processor of the computing device 400 and/or the processor 208 of the collar 200. Further, the data storage unit can take the form of at least one non-transitory computer-readable storage medium, having stored thereon program instructions (e.g., compiled or non-compiled program logic and/or machine code) that, upon execution by the processor, such as the processor 208, cause the computing device 400 to perform one or more acts and/or functions, such as those described in this disclosure. These program instructions can define, and/or be part of, a discrete software application. In some instances, the computing device 400 can execute program instructions in response to receiving an input, such as an input received via the optional communication interface and/or the user interface, such as the input mechanism 242. The data storage unit can also store other types of data.

The communication interface can allow the computing device 400 to connect with and/or communicate with another entity, such as another computing device. For example, the communication interface may allow the computing device 400 to connect and/or communicate with another entity, such as a smartphone, to store measured data on the smartphone.

The user interface, such as the input mechanism 242 of the collar 200, and/or another user interface of the computing device 400 can include hardware and/or software components that facilitate interaction between the computing device 400 and a user of the computing device 400, if applicable. As such, the user interface can include input components such as a keyboard, a keypad, a mouse, a touch-sensitive panel, and/or a microphone, and/or output components such as a display device.

The computing device 400 can take various forms. The features described herein may involve some or all of these components arranged in different ways, including additional or fewer components and/or different types of components, among other possibilities.

In an example embodiment, a method of using the collar 200 to correct undesired animal behavior is provided. The method may include positioning the collar 200 on the neck of an animal. In an example embodiment, the collar 200 may be positioned so that the sensor 206 is facing the ground 202. The sensor 206 is configured to sense the height measurement 207 between the sensor 206 and the ground 202. The method then involves the processor 208 comparing the height measurement 207 to the predetermined threshold height 201, and provides corrective feedback to the animal through the collar 200 when the measured height 207 is above the predetermined threshold height 201 because the animal exceeded the threshold height, likely by jumping or standing on its hind legs. The corrective feedback (e.g., vibration or shock) is designed to provide temporary discomfort or to surprise the animal in order to encourage the animal to modify its undesirable behavior or for the animal to stop its undesirable behavior. The method also includes outputting corrective feedback each time the measured height is greater than the threshold height until the animal associates the behavior with the feedback and modifies its behavior or stops its undesirable behavior.

The method of using the collar 200 also includes providing at least one supplemental height measurement via the altimeter and orientation information via the accelerometer. The supplemental height measurement may verify whether the collar 200 is working properly. If, at any point, during use of the collar 200, the collar 200 is not working properly (e.g., the collar is not properly positioned or the animal is laying down such that the collar 200 cannot sense the height measurement via the accelerometer), the collar 200 may be turned off (e.g., deactivated) to prevent the animal from receiving inadvertent feedback.

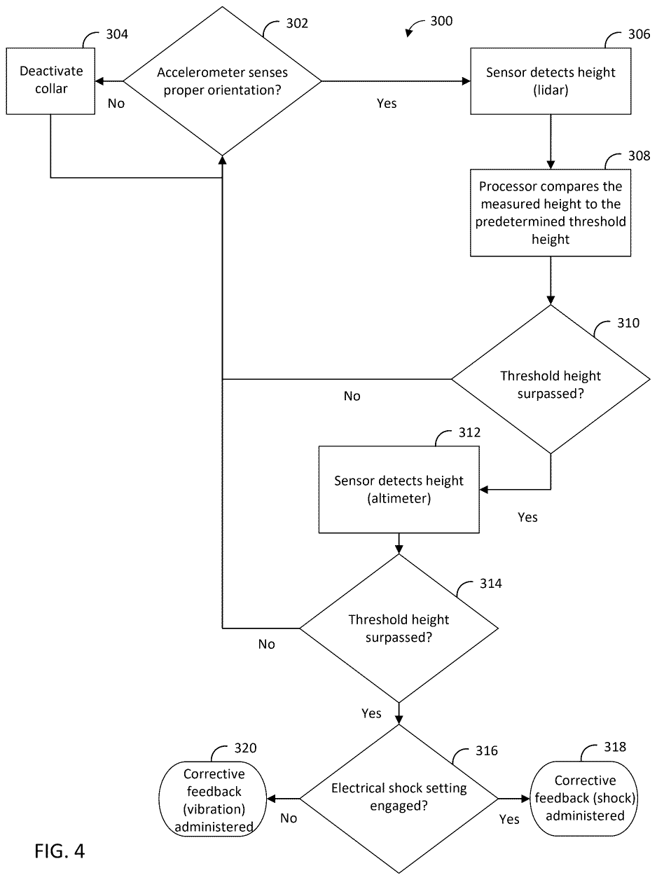

FIG. 4 is a flow chart of an example method 300 of operating the collar 200. The method 300 includes one or more operations, functions, or actions as illustrated by blocks 302, 304, 306, 308, 310, 312, 314, 316, 318, and/or 320

At block 302, the method 300 includes sensing, via the accelerometer, whether the collar 200 is in a proper orientation such that the sensor 206 is positioned on the neck of the animal 100 and is facing the ground 202.

If the collar 200 is not in the proper orientation (e.g., no at block 302), the method 300 moves to block 304. At block 304, the collar 200 is deactivated.

If the collar 200 is in the proper orientation (e.g., yes at block 302), the method 300 moves to block 306. At block 306, the sensor 206 senses the height measurement 207 between the sensor 206 and the ground 202.

Once the sensor 206 senses the height measurement 207 at block 306, the method 300 continues to block 308. At block 308, the processor 208 compares the height measurement 207 to the predetermined threshold height. The predetermined threshold height may be the height 201 and maybe input into the collar 200 via the input mechanism 242.

Once the height measurements are compared at block 308, the method 300 continues to block 310. At block 310, the processor 208 determines whether the height measurement 207 from the sensor 206 is greater than (e.g., surpasses) the predetermined threshold height 201. If the height measurement 207 from block 306 is the greater than the predetermined threshold height 201, the method 300 moves to block 312. If the height measurement 207 from block 306 is the same or less than the threshold height 201, the method returns to block 302.

At block 312, the altimeter of the sensor 206 obtains a height measurement 207 between the sensor 206 and the ground 202. Once the height is sensed at block 312, the method moves to block 314.

At block 314, the processor 208 determines whether the threshold height 201 is surpassed by the height measurement (e.g., measured by the altimeter) from block 312. If the height measurement from block 312 is surpassed, then the method 300 proceeds to block 316. If the height measurement from block 312 is equal to or less than the predetermined threshold height 201, then the method 300 returns to block 302.

At block 316, the processor 208 determines whether the electric shock setting is engaged. When the processor determines that the electric shock setting is engaged, the method 300 moves to block 318. When the processor 208 determines that the electric shock setting is not engaged, the method 300 moves to block 320.

At block 318, the processor 208 administers corrective feedback, an electrical shock, via the collar 200 (e.g., through at least one prong 240) to the neck of the animal.

At block 320, the processor 208 administers corrective feedback, a vibration, through via the collar 200 (e.g., through at least one prong 240) to the neck of the animal.

In additional example embodiments, the processor 208 may repeatedly compare the height measurement 207 to the predetermined threshold height 201, and further the processor 208 may repeatedly administer corrective feedback to the animal each time the height measurement 207 (e.g., yes at block 314) is greater than the threshold height 201. Moreover, the processor 208 is configured to stop repeatedly administering corrective feedback to the animal after a predetermined time period, such as on the order of 1 to 10 seconds, perhaps 3 seconds; however, the predetermined time period may be longer or shorter.

Moreover, in alternative example embodiments, the method 300 may proceed from block 302 to block 312, such that the processor 208 may disregard the height measurement 207 from block 306 and may rely (e.g., solely) on the height measurement from block 312 (e.g., measured via the altimeter) to determine whether feedback should be provided to the animal via the collar 200. For example, the height measurement 207 sensed at block 306 may produce a false negative. An example of a false negative may occur when the animal jumps or puts its front legs on a counter (or the like) that is above solid furniture. Because the animal is changing its position from horizontal to vertical, the sensor 206 may measure the distance from the collar 200 to the counter or the solid furniture (e.g., rather than the ground) and determine that that measured height 207 is less than the threshold height 207; however, the animal may have engaged in undesirable behavior. Thus, a false negative would occur, because the sensor height measurement 207 did not exceed the threshold height 201.

In another example embodiment, when an animal is on stairs or in an elevator, the method 300 may proceed as shown in FIG. 4. In this example embodiment, at block 306, the sensor 206 may not generate a false positive, because the sensor 206 is determining (e.g., via the lidar) the sensor height measurement 207 from the sensor 206 to the ground 202.

In an alternative example embodiment, additional blocks may be added to the method 300, such as including a block for programming the collar 200 to know that a zone, such as stairs or an elevator, are exception zones. For example, to avoid the collar 200 issuing feedback through the collar 200 when the animal walks up a staircase, emitters at the bottom and top of the staircase may provide electromagnetic signals demarcating the area of the staircase or emitters on the elevator may provide electromagnetic signals demarcating the area of the elevator, and the collar 200 may be configured to detect those electromagnetic signals as indications of when the collar 200 enters and exits the staircase area or the elevator area, to automatically deactivate the collar 200 when within the exception zone and to (e.g., automatically) re-activate the collar 200 upon exiting that area. Further, the collar 200 may be configured to (e.g., automatically) reset its ground level 202 upon exiting the area (e.g., once the animal exits the staircase or the elevator), so the collar 200 may continue operating as desired.

An owner may provide additional training tools in conjunction with using the collar 200 to train or provide feedback to an animal to correct undesired behavior. For example, a variety of training techniques or tools may be utilized to teach the animal about the new rules/consequences. In an example embodiment, an owner may use plastic flags. The plastic flags may be placed on surfaces where the owner wants to avoid the undesired behavior of the animal jumping or the animal standing on its hind legs is undesired. An example surface may be a countertop. After a week or two of seeing the flags and receiving (e.g., autonomous) behavioral corrections via the collar 200 when engaging in the undesired behavior near the flags, the animal may learn to avoid the undesired behavior in those areas. After a predetermined period of time, the flags may be removed.

Although the collar 200 provides corrective feedback to the animal, there may be cases where certain jump-related behaviors are desired (rather than discouraged), such as playing fetch, or some owners may desire for the animal to join the owner on the couch. Thus, the collar 200 may be removed from the animal or the collar 200 may be powered off, and the animal may be trained using the command “safe” and/or another command.

While some embodiments have been illustrated and described in detail in the appended drawings and the foregoing description, such illustration and description are to be considered not restrictive. Other variations to the disclosed embodiments may be understood from a study of the drawings, the disclosure, and the appended claims.

What is claimed is:

1. A collar comprising:
a strap configured to be worn by an animal;
a sensor at the strap, the sensor configured to measure a height of the sensor in relation to a ground level; and
a processor configured to receive the height measurement from the sensor, to compare the height measurement to a predetermined threshold height, and to provide feedback to the animal when the height measurement from the sensor is greater than the predetermined threshold height.

2. The collar of claim 1, wherein the strap is configured to be worn on a neck of the animal.

3. The collar of claim 2, wherein the sensor, when the strap is positioned on the neck of the animal, faces the ground level.

4. The collar of claim 1, wherein the animal is a dog.

5. The collar of claim 1, wherein the sensor comprises lidar, and, when the collar is worn by the animal, the lidar continually measures the height of the sensor in relation to the ground level.

6. The collar of claim 1, wherein the sensor comprises an accelerometer.

7. The collar of claim 1, wherein the sensor comprises an altimeter.

8. The collar of claim 1, wherein the predetermined threshold height is a height of the animal.

9. The collar of claim 1, further comprising an input mechanism, wherein the predetermined threshold height is input into the collar via the input mechanism, and wherein the predetermined threshold height is adjusted via the input mechanism.

10. The collar of claim 9, wherein the input mechanism is a dial, a button, or a display.

11. The collar of claim 1, further comprising a pair of prongs configured to provide a vibration or administer an electric shock, wherein the vibration and the electric shock are feedback to the animal to impact behavior of the animal.

12. The collar of claim 11, wherein the vibration or the electric shock provides mild and temporary discomfort configured to modify the behavior of the animal.

13. A collar comprising:
a strap configured to be worn by an animal;
a housing coupled to the strap;
a sensor coupled to the housing, the sensor configured to measure a height of the sensor in relation to a ground level; and
a processor configured to receive the height measurement from the sensor, to compare the height measurement to a predetermined threshold height, and to provide feedback to the animal when the height measurement from the sensor is greater than the predetermined threshold height.

14. The collar of claim 13, wherein the sensor senses the height measurement through a transparent portion of the housing.

15. The collar of claim 13, wherein the sensor comprises at least one of a lidar, an accelerometer, or an altimeter.

16. A method of controlling animal behavior via an animal collar, wherein the animal collar includes a strap, the method including:
measuring, via a sensor at the strap, a height of the sensor in relation to a surface;
comparing, via a processor, the measured height of the sensor to a threshold height; and
outputting corrective feedback via the collar to control behavior of the animal when the measured height is greater than the threshold height configured to modify behavior of the animal.

17. The method of claim 16, wherein outputting corrective feedback includes administering an electric shock or a vibration through at least one prong.

18. The method of claim 17, wherein the electric shock or the vibration is configured to cause mild discomfort to an animal wearing the animal collar to modify the behavior of the animal.

19. The method of claim 18, wherein the surface is the ground, and wherein the behavior of the animal is jumping or standing on hind legs of the animal.

20. The method of claim 19, further comprising repeatedly comparing the measured height of the sensor to the threshold height, and repeatedly outputting corrective feedback to the animal each time the measured height is greater than the threshold height until the animal associates the behavior with the feedback.
